(19) United States
(12) Patent Application Publication
(10) Pub. No.: US 2015/0381387 A1
(43) Pub. Date: Dec. 31, 2015

(54) System and Method for Facilitating Communication between Multiple Networks

(71) Applicant: CipherGraph Networks, Inc., Pleasanton, CA (US)

(72) Inventor: Jitender Sharan, Bangalore (IN)

(21) Appl. No.: 14/411,148

(22) PCT Filed: Jun. 19, 2013
(86) PCT No.: PCT/IB13/01284

§ 371 Date: Dec. 24, 2014

(30) Foreign Application Priority Data
Jun. 27, 2012 (IN) 2559/CHE/2012

(51) Int. Cl. H04L 12/66; H04L 12/46; H04L 29/12

(52) U.S. Cl. CPC H04L 12/66; H04L 61/2514; H04L 12/4641

(57) ABSTRACT

In one embodiment, a communication system configured for facilitating communication between multiple networks is provided. The communication system comprises a communication end point configured for handling network traffic among the plurality of networks and a network server coupling each of the networks with the communication end point via a communication channel, the network server configured for handling a communication request from at least one network entity for accessing at least one resource of at least one destination network. Further the communication end point may comprise a demultiplexer.

### FIELD OF INVENTION

The invention relates generally to data communication networks, and more particularly to techniques for facilitating communication between multiple networks.

### BACKGROUND OF THE INVENTION

Communication networks can generally be characterized as either private or public networks. In entirely private networks, communications between multiple computers, located at different locations, occur via a permanent or switched network, such as a telephone network. The communicating computers typically connect directly to each other via a dial-up or leased line connection, thereby emulating their physical attachment to one another. This type of network is usually considered private because the communication signals-travel directly from one computer to another.

Communication over packet networks, such as the Internet, is typically not private, as the network cannot guarantee packet delivery. Such networks allow packets to be injected into, or ejected out of, their circuits indiscriminately, and/or analyzed while in transit. However, to keep sensitive data communicated on such circuits private, the packets flowing on the circuit must be encrypted so that injected packets can be recognized and discarded to keep unauthorized parties from reading and analyzing data. These private circuits are called “tunnels.”

A virtual private network (VPN) is a private data network that makes use of tunnels to maintain privacy when communicating over a public telecommunication infrastructure, such as the Internet. The purpose of VPNs is to give server operators, such as corporations, the same capabilities that they would have if they had a private permanent or switched network. VPNs also cost much less to operate than other private networks, as they use a shared public infrastructure rather than a private one.

In the above, a network server may be dedicated to a single network. The network communicates to the network server through a communication end point which is identified with a single IP address. Since each network is associated with a single organization, an IP address used for identifying an autonomous network cannot be deployed for or reused by another autonomous network.

Thus, it is highly difficult to combine communication end point of any two networks seamlessly without changing at least one of them significantly. To host such disparate networks, separate network server services have to be exposed. This retires that a separate IP address be assigned for each network server that is expected to accept connections.

Hence there exists a need in the art for an efficient system and method for using a limited set of IP addresses for routing network traffic among multiple networks.

### BRIEF DESCRIPTION OF THE INVENTION

The above-mentioned shortcomings, disadvantages and problems are addressed herein which will be understood by reading and understanding the following specification.

In one embodiment, a communication system configured for serving as a communication gateway for multiple networks is provided. The communication system comprises at least one network server configured for providing intermediate connection between a peer network and a destination network and a communication end point coupled to the network server, the communication end point capable of being addressed by at least one public network address and further configured to receive one or more communication requests from the peer network and wherein the communication end point comprises a address translation module configured to correlate the peer network to the destination network based on the communication request so as to enable communication between the peer network and the destination network.

In another embodiment a method of facilitating communication between multiple networks on a single and scalable infrastructure is provided. The method comprises steps of receiving a communication request from a peer network at a communication end point, the communication end point capable of being addressed by at least one public network address, identifying a destination network based on the communication request comprising a private network address and enabling communication between the peer network and the destination network based on the identification.

In yet another embodiment, a method of facilitating communication between multiple networks on a single and scalable infrastructure is provided. The method comprises assigning at least one public network address for handling network traffic of at least two destination networks, receiving a communication request from a peer network at a communication end point, the communication end point capable of being addressed by at least one public network address, identifying a destination network based on the communication request comprising a private network address and enabling communication between the peer network and the destination network based on the identification.

Systems and methods of varying scope are described herein. In addition to the aspects and advantages described in this summary, further aspects and advantage will become apparent by reference to the drawings and with reference to the detailed description that follows.

### BRIEF DESCRIPTION OF THE DRAWINGS

FIG. 1 shows a block diagram of a communication system configured for hosting multiple networks as described in an exemplary embodiment;

FIG. 2 shows a block diagram of a communication system configured for hosting multiple users of a single autonomous network as described in another exemplary embodiment;

FIG. 3 shows a flow diagram of a method of hosting multiple networks as described in one embodiment; and

FIG. 4 shows a slow diagram of a method of hosting multiple networks as described in one embodiment.

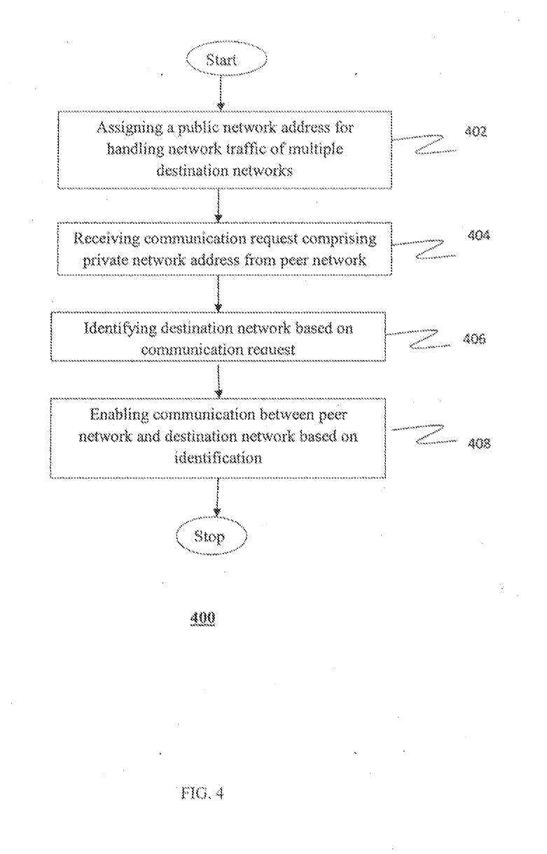

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

In one embodiment, the invention describes a mechanism of multiple network servers on a single or pre-determined set of IP (Internet Protocol) addresses so as to provide network access to multiple entities desiring access to one or more networks. For this purpose, the invention employs demultiplexing process to route the incoming data packets to respective network servers based on an identification header in the data packet that uniquely identities the packet's destination network server.

Accordingly, in one embodiment, the invention provides a system and method for using a set of IP addresses for handling network traffic to multiple networks wherein the number of networks is more than the number of IP addresses. Accordingly, the invention, provides system and method for reusing, a set of IP addresses for handling network traffic among a plurality of networks without letting the network traffic of either of these networks reach the other.

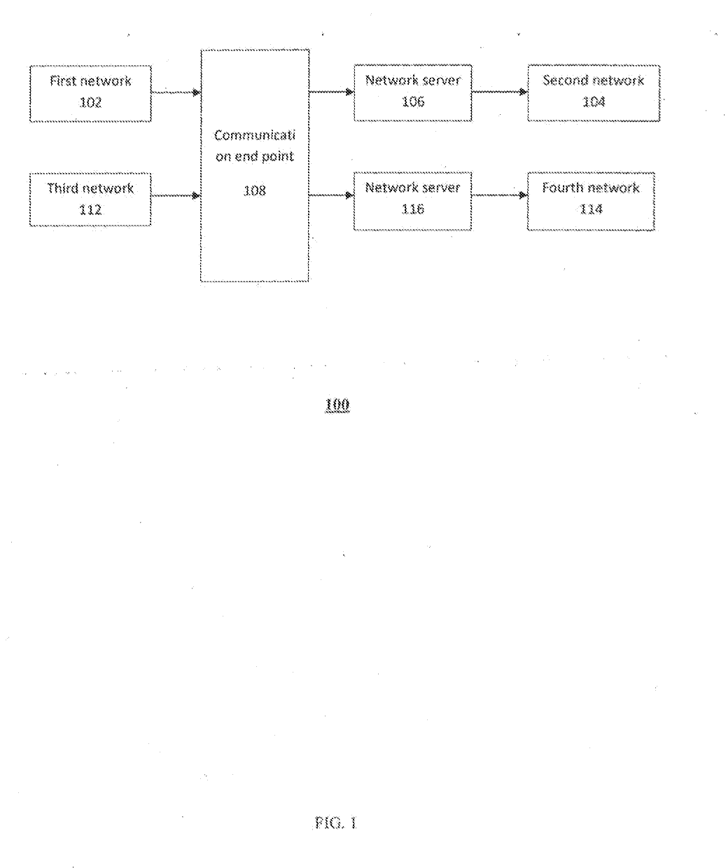

In one embodiment, as shown in FIG. 1, a communication system 100 configured for facilitating communication between multiple networks 102 and 104, and 112 and 114 is provided. The communication system 100 comprises a communication end point 108 configured for handling network traffic among the plurality of networks 102 and 104, and 112 and 114 and a network server 106 and 116 coupling each of the networks 102 and 112 with the communication end point 108, the network server 106 and 116 configured for handling a communication request from at least one network entity 102 ad 112 for accessing at least one resource of at least one network 104 and 114.

The communication end point 188 is configured for controlling network access for multiple entities (Home/Branch networks and the teleworkers) to desired network. The communication end point runs the VPN server software. Each of the networks is capable of functioning as a source network and a destination network depending on a scenario. Further each of the networks may be one of a home network, a branch network and a transient network (such as a one used by a teleworker).

The teleworker is a mobile entity who can gain access to the network from a communication device. The personal communication device may comprise one of a smart phone, personal computer, notebook, tablet (not shown), personal digital assistant, connected television (not shown) and any such device capable of having access to the Internet.

The first network entity desiring to communicate with a second network entity can be termed as a peer network or a source network and whereas the network entity that is being accessed can be termed as a destination network.

Further, each of the networks is coupled to a network server that receives network traffic directed at the associated network. The network server is connected to a destination network using some kind of site-to-site secure connectivity. This enables the destination network to extend remote access connectivity to one or more transient networks using a site-to-site (STS) VPN.

Once a communication channel (also referred to as tunnel) has been established between the communication end point and the network server, of a destination network, the peer network can access of the destination network's computing resources through the tunnel. Tunnels are typically established through Virtual Private Network (VPN) technologies and establish a secure communication channel through which information can be transmitted between networks.

The network server is connected to an organization's network using some kind of site-to-site secure connectivity. This enables the organization to extend remote access connectivity to one or more teleworkers using just a site-to-site (STS) VPN.

Through this channel, application client software (e.g., email client, word processor, web browser, database client) installed on the communication device communicates with internal resources of the destination network. The network server can take care of user authentication, access control (at the host, service, and application levels), and other security functions for transient networks (teleworkers).

The types of VPNs most commonly used for teleworkers are Internet Protocol Security (IPSec) and Secure Sockets Layer (SSL) tunnels. IPSec provides network communication security for operating systems. Tunneling may also be achieved by using Secure Shell (SSH), although this is less commonly used and is often considered more difficult to configure and maintain than IPSec or SSL tunnel VPNs. All three forms of tunneling mentioned in this section can protect many protocols at once.

The network server can control access to at least a part of the network and the types of access that a teleworker gets post authentication. For example, a network server might allow a user to only have access to one subnet, or to only run particular applications on certain servers on the protected network. In this way, even though the cryptographic tunnel ends at the network server, the gateway can add additional routing to the teleworker's traffic to only allow access to some parts of the internal network.

Both the communication end point and the network server may be established and managed by a client whose resources are to be accessed through the communication end point and the network server. However, the communication end point and the network server may also be established and managed by a third party.

Each of the communication end point, communication channel and network server are one of physically hosted, virtually hosted and cloud hosted entities.

Network is an entity that an organization owns, and comprises at least a part of the server and/or service that the organization provides. Specifically the network comprises a set of internal resources that an organization wishes to allow remote access to. The network comprises one of a Domain Name Server, a Windows Internet Name Server, that resolve user friendly names of servers/services to the real IP addresses.

Further the system comprises multiple networks and each of the networks may be a cloud hosted entity, physical on-premise entity and virtualized entity. Cloud hosted networks are typically employed by startup organizations.

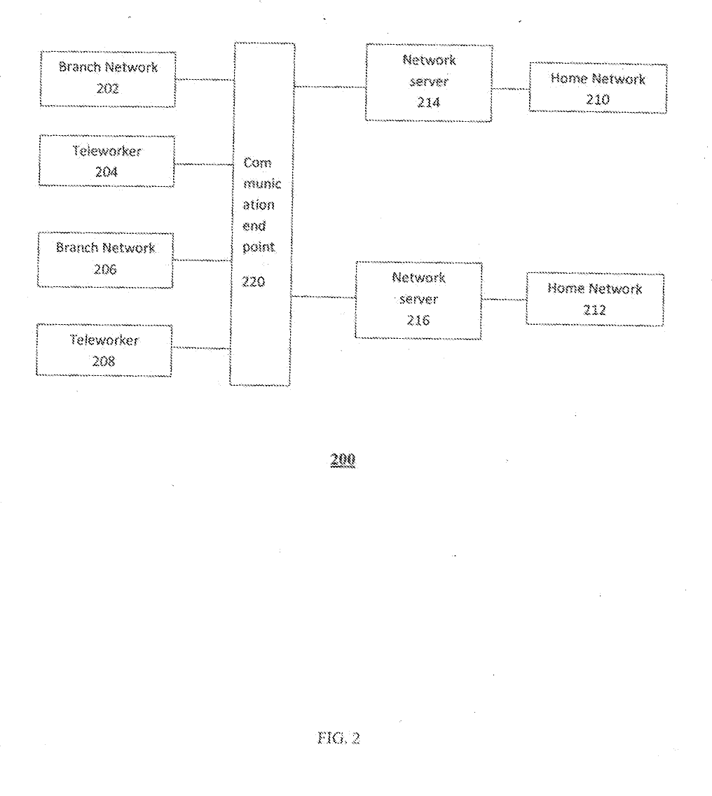

In one embodiment, the network can be accessed using multiple entities by a user. The network access between multiple entities is through the communication end point. The entitles include home, network, branch network and a teleworker. In an exemplary embodiment shown in FIG. 2, a communication system 200 comprises a first network and a second network. Each of the first network and the second network comprise a branch network 202 and 212, a teleworker 204 and 214, and a home network 206 and 216 respectively. The branch network 202 and teleworker 204 may be trying to access one or more resource from home network 206 of the same organization. Further, the branch network 202 and teleworker 204 are connected to the home network 206 through a network server 208. Similarly, the branch network 212 and teleworker 214 may be trying to access one or more resource from home network 216 of the same organization. Further, as shown in FIG. 2, the branch network 212 and teleworker 214 are connected to the home network 216 through a network server 218. A communication end point 210 couples the branch networks 202 and 212, and the teleworkers 204 and 214 to the-respective home networks 206 and 216 via the respective network server 208 and 218.

Though the exemplary embodiment shown in FIG. 2, shows the branch network 102 and teleworker 104 trying to access the homo network 108, skilled artisans shall however appreciate that any single network trying so access resources of another network falls within the scope of the invention. Further, each of such autonomous networks trying to gain access into another network can be termed as entity for the simplicity of explanation.

The network server may comprise at least one server and/or service that receives one or more communication requests from the user and determines whether or not the user may be granted access to it. After such decision the VPN also routes or proxies authorized requests to the network. Though, for the sake of simplicity, the network server and the network are shown co-located, skilled artisans shall appreciate that the network server and the network need not be co-located.

Access rules are the rules that allow/deny access to a user to the service the user requests. These determine the user's rights based on his identity, group, organization structure, the current network and the communication device the user employs to gain access among other policy parameters. For every request that a user makes, a decision is taken based on these rules whether to allow/deny that request to be processed.

Each of the home network and/or branch network is a private network that is hosted physically or in a private/hosted cloud or virtualized. The home network may represent network of head office of an organization and the branch network may represent the branch office of the organization. Further, as can be comprehended by skilled artisans, the branch network may be optional.

Further, based on the entity trying to access the network, the incoming IP address is one of a static and a dynamic IP address. More specifically, physical and/or cloud hosted entities including home network and branch network entities are identified by a static IP address. In one exemplary embodiment, each of the network entities may use an internal addressing schema that is private to the respective network entities and which may be incompatible with generally accepted standard.

The communication end point is configured to act as a Network Address Translation (NAT) device with an inward rule based on IP address. Therefore, an IP packet sourced from a home network or branch network is directly sent to a corresponding network with the specified IP address. Further, outbound path of an outgoing IP packet is routed in a similar manner.

Even though it is possible to demultiplex fixed-IP peers based on incoming IPs, this does not work for teleworkers or other peers that do not have a static IP to initiate connections from and rather have a dynamic IP. For this purpose, the identity of the remote entity is deduced based on data inside the packet.

Typically aggressive mode sends specific identifying information in the first packet that is sourced from a peer network. This allows stateless traversal of the intermediate infrastructure. However in non-aggressive mode, the specific identifying information is absent in the first packet that is sourced from the peer network.

Virtual private networks, using digital certificates can be identified without resorting to decryption. A certifying authority can be configured to control the issuance of certificates that are used for user authentication across multiple networks. Further, the certifying authority is configured to ensure that the digital certificates issued are uniquely identifiable for each entity trying to access one among the multiple networks.

The certification authority s a part of the communication end point and is configured to generate a public/private key pair and a set of digital certificates for each network server. The communication end point and the corresponding network server negotiate mutually acceptable set of keys.

In one embodiment, the certifying authority may be a Public Key Infrastructure (PKI) synchronizer that is configured to generate keys comprising alpha-numeric codes that are encrypted for security purposes.

PKI enables users of an unsecured public network, such as the Internet, to securely and privately exchange data through the use of public and private cryptographic key pairs that are obtained and shared through a trusted authority. PKI provides for Digital Certificates that cars identify individuals or organizations. A Digital Certificate is an electronic “credit card” that establishes a sender's credentials. It comprises the senders name, a serial number, expiration dates, a copy of the certificate holder's public key (used for encrypting and decrypting messages and digital signatures), and the digital signature of the certificate-issuing authority so that a recipient can verify that the certificate is real.

Ensuring the issuance of uniquely identifiable key and thereby avoiding issuance of duplicate keys facilitates multiplexing as digital certificate of an entity can be mapped to a corresponding network server for which the access is seeked. Subsequently one or more communication requests can be routed to the corresponding network server. For this purpose, a forwarding rule can be generated upon identifying the network server for which the access is seeked. The forwarding rule directs forwarding the subsequent VPN traffic packets sourced from the remote entity's to a corresponding network server.

On the other hand, an entity may also try to access a network using a pre shared key. However, each entity is typically provided with multiple pre shared keys and hence the communication end point is configured to match the pre shared key with each of the networks to identify a network for which the access is seeked. Therefore for an entity trying to access a network with a pre shared key, the pre shared key is verified with each of the network servers and then a successful network server receives the subsequent IP packets.

It is to be noted that the pre shared key issued by a network cannot be used by another network and hence the certifying authority is configured to ensure that FSKs are unique for multiple networks that are coupled to a single communication end point that is identified by a single public IP.

Skilled artisans shall appreciate many ways of achieving this purpose. In one exemplary embodiment, a set of PSKs pertaining to a single network may be associated with a code that uniquely identifies the network. More specifically, multiple PSKs associated with a single network may have a prefix that is associated with a single network. Hence, PSKs issued by each of the networks may be prefixed with a code that is associated with the network.

Further, for a communication end point identified with a public IP and coupled to multiple network servers each configured for handling network traffic to a single destination network, each destination network may have a PSK with a unique prefix of the form PSK_Cx wherein Cx is associated with a single destination network.

Therefore the forward rule may identify a network server based on the prefix associated with the pre shared key embedded in the IP header of a packet sourced from an entity trying to access a network with the pre shared key. Upon identification, subsequent IP packets may be directed to the corresponding network.

The communication end point is configured to exhaustively match multiple possible PSKs, since it does not require any information sharing, for this purpose, the communication end point may have multiple computing units pertaining to a single PSK or set of PSKs. Employing multiple computing units minimises the delay in mapping the IP packet to a corresponding network and subsequently in forwarding the IP packet to the corresponding network. In order to save compute cycles, a mapping of the incoming IP packet and the corresponding network server may be stored in cache and referred for handling subsequent IP packets. However, the mapping may be performed periodically and for each communication request.

In a stateful mode, one or more packets may be received prior to the packet that comprises the identifying information. The stateful mode is applicable to a communication request made using one of a pre shared key and a digital certificate. Hence the identifying information may comprise an encrypted form of one of the pre shared key and the digital certificate. The initial packets comprise negotiation parameters for association.

The communication end point accepts incoming IP packets that do not have a forward rule configured. The communication end point is further configured to negotiate association parameters and caches the negotiation. The communication end point receives one or more IP packets comprising the identification information and subsequently, sends the negotiated information to a corresponding VPN and the VPN populates its records as if it had itself negotiated these parameters.

The communication end point creates a NAT-forwarding role for this peer and following the creation of the forwarding rule sends all packets including the IP packet comprising the identification information to an identified VPN.

Since each network server is specific to a single organization's deployment it is possible to have separate negotiation parameters for each of the network servers. For this purpose, the communication end point is configured to appropriately negotiate the association parameters.

As an extension, a single communication end point may be configured to handle network traffic directed to one or more network servers that have the same negotiation parameters. Understandably, the communication system may comprise multiple communication end points. Though, FIG. 1 and FIG. 2 show the communication systems 100 and 200 as having a single communication end point 108 and 220 respectively, for the sake of simple explanation, skilled artisans shall appreciate tat the communication system may comprise multiple communication end point each being coupled to one or more network servers each of which are deployed for a single organization.

Although not shown, the communication system may further comprise a firewall coupled to each network server for providing a secure connection. The firewall is a set of related programs located at the server-side system that protects the resources of the LAN from users connected to the Internet. The firewall also works with the proxy server to make network requests on behalf of corporate workstation users (not shown). The firewall is preferably installed on a computer separate from the rest of the LAN so that no incoming request can access private network resources. Alternatively, the firewall may form part of another computer, such as the router or network server. There are a number of firewall screening methods that may be used in conjunction with the invention. One such method is to screen requests to make sure they come from acceptable (previously identified) IP addresses. In the present invention, the firewall allows remote access to the VPN by the use of secure logon procedures and authentication certificates.

Further, similar to the networks that are hosted on cloud, firewalls can also be cloud hosted.

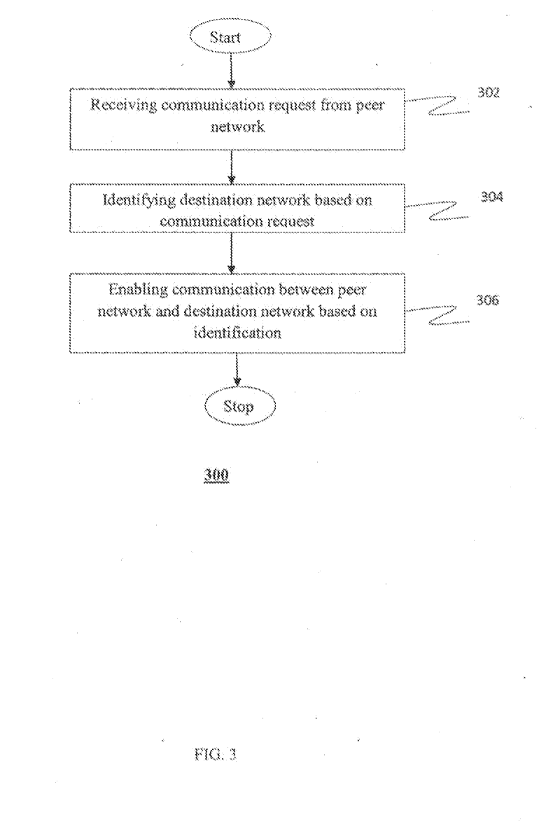

In another embodiment, as shown in FIG. 3, a method 300 of facilitating communication between multiple networks on a single and scalable infrastructure is provided. The method comprises receiving an interact protocol packet from a source at step 302, the internet protocol packet comprising identification data corresponding to a network, decoding the identification data at step 304 and handling the internet protocol packet to the corresponding network through a communication channel associated with the network at step 306. Further, the handling may comprise demultiplexing.

In yet another embodiment, a method 400 of facilitating communication between multiple networks on a single and scalable infrastructure is provided. The method comprises assigning a set of IP addresses for handling network traffic for multiple networks at step 402, wherein the number of networks is more than the number of IP addresses, receiving communication request comprising a private network address from a peer network at step 404, identifying a destination network based on the communication request at step 406 and enabling communication between the peer network and the destination network based on the identification at step 408.

In yet another embodiment, a computer program product stored on a computer readable media comprising instructions tor execution by a processor so as to result in facilitating communication between multiple networks on a single and scalable infrastructure is provided. The instructions comprise code for assigning a set of IP addresses for handling network traffic for multiple networks wherein the number of networks is more than the number of IP addresses and code for reusing at least one IP address for handling network traffic of at least two autonomous networks, wherein the network traffic is directed to a corresponding network among the two networks. Further, the handling of network traffic comprises demultiplexing.

In one specific embodiment, the communication end point may be a processing unit configured for executing a set of instructions comprising code for receiving an internet protocol packet from a source, the internet protocol packet

comprising identification data corresponding to a network, code for decoding the identification data and code for routing the internet protocol packet to the corresponding network through a communication channel associated with the network. Further, the routing may comprise demultiplexing.

It will be apparent from this description that aspects of the present invention may be embodied, at least in part, in software, hardware, firmware, or in combination thereof. That is, the techniques may be carried out in a computer system or other data processing system in response to its processor, such as a microprocessor, executing sequences of instructions contained in a memory, such as ROM, volatile RAM, non-volatile memory, cache, or a remote storage device (not shown). In various embodiments, hardwired circuitry may be used in combination with software instructions to implement the present invention.

Thus, the techniques are not limited to any specific combination of hardware circuitry and software or to any particular source tor the instructions executed by the data processing system. In addition, throughout this description, various functions and operations are described as being performed by or caused by software code to simplify description. However, those skilled in the art will recognize that what is meant by such expressions is that the functions result from execution of code by a processor, such as the microprocessor.

In various embodiments of the invention, a communication end point for a communication system and a communication system using a communication end point are described. However, the embodiments are not limited and may be implemented in connection with different applications. The application of the invention can be extended to other areas.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A communication system configured for serving as a communication gateway for multiple networks, the communication system comprising:
at least one network server configured for providing intermediate connection between a peer network and a destination network; and
a communication end point coupled to the network server, the communication end point capable of being addressed by at least one public network address and further configured to receive one or more communication requests from the peer network and wherein the communication end point comprises a address translation module configured to correlate the peer network to the destination network based on the communication request so as to enable communication between the peer network and the destination network.

2. The communication system of claim 1, wherein the communication request comprises a private network address.

3. The communication system of claim 1, wherein each destination network is addressed by a private network address.

4. The communication system of claim 2, wherein each of the public network address and the private network address comprise one of a DNS, WINS and IP address.

5. The communication system of claim 1, wherein each of the peer network and the destination network is one of a home network, branch network and a transient network.

6. The communication system of claim 1, wherein the network server comprises a virtual private network server and employs one of an Internet Protocol Security and a Secure Socket Layer for communication.

7. The communication system of claim 1, wherein the communication request comprises one of an access request and a data request.

8. The communication system of claim 1, wherein each of the communication end point and the network server are one of physically hosted, virtually hosted and cloud hosted entities.

9. A method for facilitating communication between multiple networks, the method comprising:
receiving a communication request from a peer network at a communication end point, the communication end point capable of being addressed by at least one public network address;
identifying a destination network based on the communication request comprising a private network address; and
enabling communication between the peer network and the destination network based on the identification.

10. The method of claim 9, wherein the communication between the peer network and the destination network is enabled via a network server.

11. The method of claim 9, wherein each of the public network address and private network address comprise one of a DNS, WINS and IP address.

12. The method of claim 9, wherein the private network address comprises a digital certificate.

13. The method of claim 12, wherein identifying the destination network comprises:
mapping each digital certificate with a corresponding network server.

14. The method of claim 9, wherein the private network address comprises a pre shared key and wherein each destination network is associated with at least one pre shared key.

15. The method of claim 14, wherein identifying the destination network comprises:
verifying the pre shared key with multiple network servers so as to determine the association between the pres hared key and a corresponding network server.

16. A method of hosting multiple networks on a single and scalable infrastructure, the method comprising:
assigning at least one public network address for handling network traffic of at least two destination networks;
receiving a communication request from a peer network at a communication end point, the communication end point capable of being addressed by at least one public network address;
identifying a destination network based on the communication request comprising a private network address; and
enabling communication between the peer network and the destination network based on the identification.

17. The method of claim 16, wherein each network is one of a peer network and a destination network.

18. The method of claim 16, wherein each of the public network address and private network address comprise one of a DNS, WINS and IP address.
